(19) United States
(12) Patent Application Publication
(10) Pub. No.: US 2022/0049847 A1
(43) Pub. Date: Feb. 17, 2022

(54) SYSTEM FOR RECYCLING WASTE HEAT USING SOLID REFUSE FUEL INCINERATOR

(71) Applicant: Hea Gwun YU, Chungcheongbuk-do (KR)

(72) Inventor: Hea Gwun YU, Chungcheongbuk-do (KR)

(21) Appl. No.: 17/242,476

(22) Filed: Apr. 28, 2021

(30) Foreign Application Priority Data
Aug. 14, 2020 (KR) 10-2020-0102551

(51) Int. Cl. F23G 5/00; F23G 5/46

(52) U.S. Cl. CPC F23G 5/006; F23G 2206/203; F23G 5/46

(57) ABSTRACT

There is provided a system for recycling waste heat using a solid refuse fuel incinerator, the system including: a solid refuse fuel incinerator configured to incinerate solid refuse fuel supplied into the solid refuse fuel incinerator, the solid refuse fuel incinerator being configured to discharge exhaust gas produced during the incineration; a harmful material precipitator configured to adsorb and precipitate a harmful material by injecting adsorption water to the discharged exhaust gas; a precipitation water filtering device configured to filter and purify precipitation water in which the harmful material is adsorbed and precipitated; a steam power generator configured to generate electricity using steam produced by heat exchange between waste heat of the incinerator and cooling water supplied to cool the solid refuse fuel incinerator; and a hydroponic cultivator configured to be supplied with clean water purified by the precipitation water filtering device and perform hydroponics using the supplied clean water.

### CROSS-REFERENCE TO RELATED APPLICATIONS

This application claims the priority of Korean Patent Application No. 10-2020-0102551 filed on Aug. 14, 2020, in the Korean Intellectual Property Office, the disclosure of which is incorporated herein by reference.

### FIELD

The present disclosure relates to a system for recycling waste heat using a solid refuse fuel incinerator, and more particularly, to a system for recycling waste heat using a solid refuse fuel incinerator, in which adsorption water is injected to an exhaust gas, which is produced during incineration of solid refuse fuel, to adsorb contaminants, precipitation water, in which the contaminants are adsorbed, is filtered to remove the contaminants, water is supplied to be used as the precipitation water and used for hydroponics, and electricity is generated using steam produced as the solid refuse fuel incinerator is cooled, such that it is possible to effectively recycle the waste heat and the exhaust gas, which are generated during the incineration of the solid refuse fuel, in order to generate electricity and perform hydroponics.

### BACKGROUND

Various wastes are being discharged due to development of industries and improvement of life levels. For example, when flammable wastes such as waste plastic, waste vinyl materials, and waste tires are buried underground, serious environmental contamination is caused. Therefore, the flammable wastes are being treated in an incineration manner.

The quantity of flammable wastes in Korea in 2015 is known to be 22.11 million tons. There has been proposed a technology for producing solid refuse fuel (SRF) using the flammable waste instead of simply incinerating the flammable wastes.

It is known that there are about 246 facilities for manufacturing the solid refuse fuel (SRF) in Korea in 2016. The solid refuse fuel is used in thermal power stations, paper factories, cement factories, textile factories, and the like.

Meanwhile, there have been developed various technologies capable of using waste heat, which is generated during incineration of the solid refuse fuel, for various purposes in order to produce hot blast, hot water, steam, and the like by recycling and using heat, which is generated during the incineration of the solid refuse fuel in an incinerator.

### SUMMARY

An aspect of the present invention provides a system for recycling waste heat using a solid refuse fuel incinerator, in which adsorption water is injected to an exhaust gas, which is produced during incineration of solid refuse fuel, to adsorb contaminants, precipitation water, in which the contaminants are adsorbed, is filtered to remove the contaminants, water is supplied to be used as the precipitation water and used for hydroponics, and electricity is generated using steam produced as the solid refuse fuel incinerator is cooled, such that it is possible to effectively recycle the waste heat and the exhaust gas, which are generated during the incineration of the solid refuse fuel, in order to generate electricity and perform hydroponics.

An aspect of the present disclosure also provides a system for recycling waste heat using a solid refuse fuel incinerator, in which solid refuse fuel is supplied to and incinerated by the stoker incinerator, the solid refuse fuel is primarily incinerated at a lowermost stage, the non-combusted material remaining after the primary incineration is secondarily incinerated at an upper stage positioned above the lowermost stage, and the non-combusted material remaining after the secondary incineration is tertiarily incinerated at a stage positioned above the upper stage, such that it is possible to completely incinerate the harmful materials containing dioxin.

An aspect of the present disclosure also provides a system for recycling waste heat using a solid refuse fuel incinerator, in which exhaust gas, which is produced during incineration of solid refuse fuel, is introduced into and discharged from a harmful material precipitator, water supplied from a hydroponic cultivator is injected downward, as the adsorption water, to adsorb and precipitate harmful gas and contaminants, and the harmful gas and the contaminants are removed from precipitation water, and then clean water is discharged, such that it is possible to recycle and use the discharged clean water for hydroponics.

An aspect of the present disclosure also provides a system for recycling waste heat using a solid refuse fuel incinerator, in which cooling water is supplied to cool a solid refuse fuel incinerator, steam is produced by heat exchange between the supplied cooling water and the waste heat of the incinerator, and electricity is generated using the steam, such that it is possible to perform hydroponics using the generated electricity.

According to an aspect of the present disclosure, there is provided a system for recycling waste heat using a solid refuse fuel incinerator, the system including: a solid refuse fuel incinerator configured to incinerate solid refuse fuel supplied into the solid refuse fuel incinerator, the solid refuse fuel incinerator being configured to discharge exhaust gas produced during the incineration; a harmful material precipitator configured to adsorb and precipitate a harmful material by injecting adsorption water to the discharged exhaust gas; a precipitation water filtering device configured to filter and purify precipitation water in which the harmful material is adsorbed and precipitated; a steam power generator configured to generate electricity using steam produced by heat exchange between waste heat of the incinerator and cooling water supplied to cool the solid refuse fuel incinerator; and a hydroponic cultivator configured to be supplied with clean water purified by the precipitation water filtering device and perform hydroponics using the supplied clean water and the generated electricity, the hydroponic cultivator being configured such that the water used for the hydroponics is supplied again as the adsorption water.

In the system for recycling waste heat using the solid refuse fuel incinerator according to the aspect of the present disclosure, the solid refuse fuel incinerator may be a reverse feed stoker incinerator that incinerates the solid refuse fuel while conveying the solid refuse fuel from a bottom side to a top side.

In the system for recycling waste heat using the solid refuse fuel incinerator according to the aspect of the present disclosure, the solid refuse fuel incinerator may include: an incinerator main body having an incineration space therein and including a supply passage through which the solid refuse fuel is supplied, and a first exhaust pipe through which the exhaust gas is discharged; a supply conveyor configured to the solid refuse fuel into the incinerator main body; a primary incineration region in which the solid refuse fuel is supplied to a primary stoker and primarily incinerated; a secondary incineration region disposed above the primary incineration region and communicating with the primary incineration region, the secondary incineration region being configured such that non-combusted material remaining after the primary incineration is secondarily incinerated; a tertiary incineration region disposed above the secondary incineration region and communicating with the secondary incineration region, the tertiary incineration region being configured such that the non-combusted material remaining after the secondary incineration is tertiarily incinerated; an air blower configured to supply air to the primary incineration region; and a heating means configured to heat the primary incineration region, the secondary incineration region, and the tertiary incineration region.

In the system for recycling waste heat using the solid refuse fuel incinerator according to the aspect of the present disclosure, the solid refuse fuel incinerator may have stationary stokers provided in the primary incineration region, the secondary incineration region, and the tertiary incineration region, respectively, and after the incineration, a movable stoker may be used to move the non-combusted material to the subsequent incineration region.

In the system for recycling waste heat using the solid refuse fuel incinerator according to the aspect of the present disclosure, a second stationary stoker in the secondary incineration region may have heating holes that penetrate upper and lower portions of the second stationary stoker and are inclined upward and disposed in a split ring shape.

In the system for recycling waste heat using the solid refuse fuel incinerator according to the aspect of the present disclosure, the harmful material precipitator may include: a tubular precipitator main body into which the exhaust gas is introduced and from which high-temperature air and the precipitation water, in which the harmful material is adsorbed and precipitated, are discharged; an adsorption water supply pipe provided at an upper side in the precipitator main body and configured to supply water from the hydroponic cultivator as the adsorption water; and a water injection nozzle provided on the adsorption water supply pipe and configured to inject the adsorption water downward.

In the system for recycling waste heat using the solid refuse fuel incinerator according to the aspect of the present disclosure, the harmful material precipitator further may include a plurality of partition walls provided at the upper side in the precipitator main body and configured to inhibit a movement of the exhaust gas.

In the system for recycling waste heat using the solid refuse fuel incinerator according to the aspect of the present disclosure, the precipitator main body may include: a first inlet pipe into which the exhaust gas is introduced; a first drain pipe through which the precipitation water is discharged to the precipitation water filtering device; and a second exhaust pipe through which the high-temperature air is discharged to the outside.

In the system for recycling waste heat using the solid refuse fuel incinerator according to the aspect of the present disclosure, the plurality of precipitation water filtering devices may be provided, and each of the precipitation water filtering devices may include: a filtering device main body into which the precipitation water is introduced and from which the clean water from which the harmful material is removed is discharged; and an activated carbon filter provided in the filtering device main body and configured to adsorb and remove the harmful material.

In the system for recycling waste heat using the solid refuse fuel incinerator according to the aspect of the present disclosure, the filtering device main body may include: a second inlet pipe into which the precipitation water is introduced; and a second drain pipe from which the clean water is discharged.

In the system for recycling waste heat using the solid refuse fuel incinerator according to the aspect of the present disclosure, the steam power generator may include: a heat exchange pipe provided in the solid refuse fuel incinerator and configured to be supplied with the cooling water and to discharge steam generated by heat exchange with the waste heat; a steam turbine configured to operate using the discharged steam; and an electric generator connected to the steam turbine and configured to generate electricity.

In the system for recycling waste heat using the solid refuse fuel incinerator according to the aspect of the present disclosure, the heat exchange pipe may be provided in the main body of the solid refuse fuel incinerator or provided on the stoker of the solid refuse fuel incinerator.

According to the present disclosure, the adsorption water is injected to the exhaust gas, which is produced during the incineration of the solid refuse fuel, to adsorb contaminants, the precipitation water, in which the contaminants are adsorbed, is filtered to remove the contaminants, the water is supplied to be used as the precipitation water and used for the hydroponics, and the electricity is generated using the steam produced as the solid refuse fuel incinerator is cooled. As a result, it is possible to effectively recycle the waste heat and the exhaust gas, which are generated during the incineration of the solid refuse fuel, in order to generate electricity and perform hydroponics.

Further, according to the present disclosure, the solid refuse fuel is supplied to and incinerated by the stoker incinerator, the solid refuse fuel is primarily incinerated at a lowermost stage, the non-combusted material remaining after the primary incineration is secondarily incinerated at an upper stage positioned above the lowermost stage, and the non-combusted material remaining after the secondary incineration is tertiarily incinerated at a stage positioned above the upper stage. As a result, it is possible to completely incinerate the harmful materials containing dioxin.

In addition, according to the present disclosure, the exhaust gas, which is produced during the incineration of the solid refuse fuel, is introduced into and discharged from the harmful material precipitator, the water supplied from the hydroponic cultivator is injected downward, as the adsorption water, to adsorb and precipitate the harmful gas and the contaminants, and the harmful gas and the contaminants are removed from the precipitation water, and then the clean water is discharged. As a result, it is possible to recycle and use the discharged clean water for the hydroponics.

Further, according to the present disclosure, the cooling water is supplied to cool the solid refuse fuel incinerator, the steam is produced by the heat exchange between the supplied cooling water and the waste heat of the incinerator, and the electricity is generated using the steam. As a result, it is possible to perform the hydroponics using the generated electricity.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block configuration view of a system for recycling waste heat using a solid refuse fuel incinerator according to an exemplary embodiment of the present disclosure;

FIGS. 2, 3, 4 and 5 are views for explaining a solid refuse fuel incinerator according to the exemplary embodiment of the present disclosure;

FIG. 6 is a view for explaining a harmful material precipitator according to the exemplary embodiment of the present disclosure;

FIG. 7 is a view for explaining a precipitation water filtering device according to the exemplary embodiment of the present disclosure;

FIGS. 8 and 9 are views for explaining a steam power generator according to the exemplary embodiment of the present disclosure; and

FIG. 10 is a view for explaining a hydroponic apparatus according to the exemplary embodiment of the present disclosure.

### DETAILED DESCRIPTION

Exemplary embodiments of the present disclosure will now be described in detail with reference to the accompanying drawings.

Hereinafter, exemplary embodiments of a system for recycling waste heat using a solid refuse fuel incinerator according to the present disclosure will be described in detail with reference to the drawings.

However, it should be noted that the intrinsic technical spirit of the present disclosure is not limited by the following exemplary embodiment, and the following exemplary embodiment may easily be substituted or altered by those skilled in the art based on the intrinsic technical spirit of the present disclosure.

In addition, the terms used herein are selected for convenience of description and should be appropriately interpreted as a meaning that conform to the technical spirit of the present disclosure without being limited to a dictionary meaning when recognizing the intrinsic technical spirit of the present disclosure.

Hereinafter, the exemplary embodiment of the present disclosure will be described with reference to the accompanying drawings.

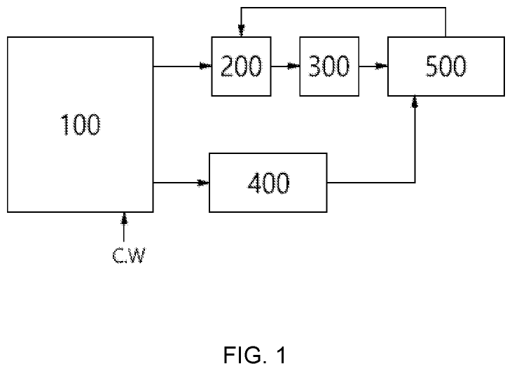

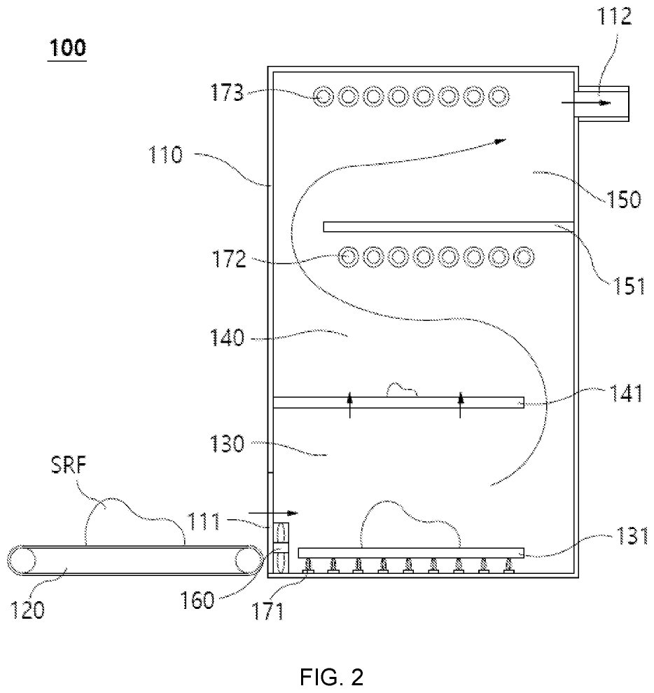

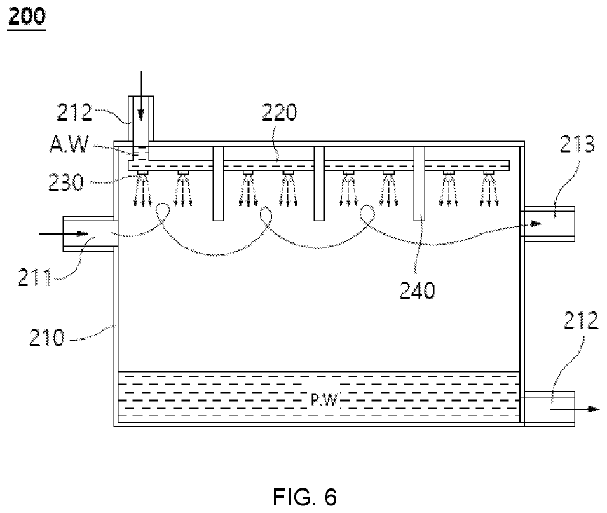

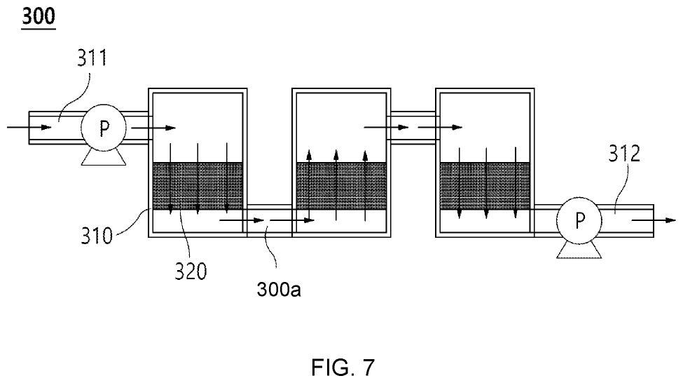

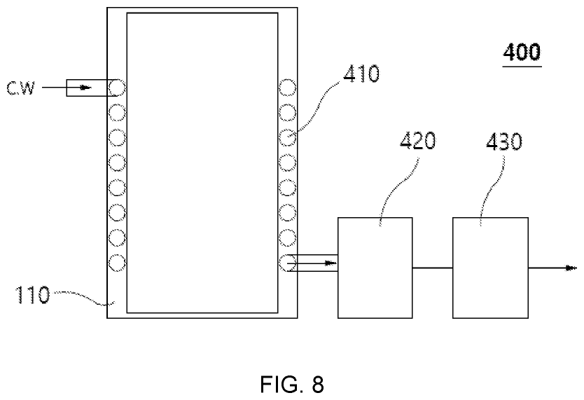

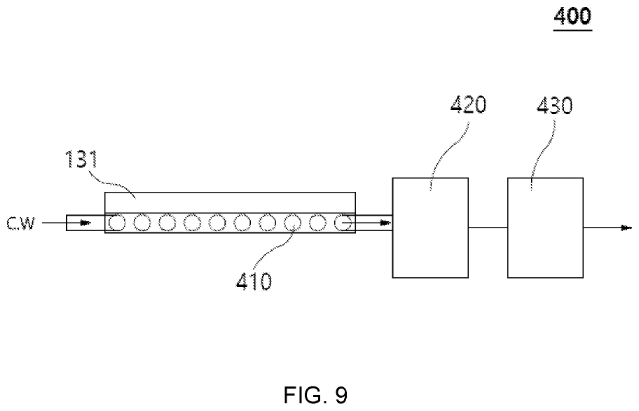

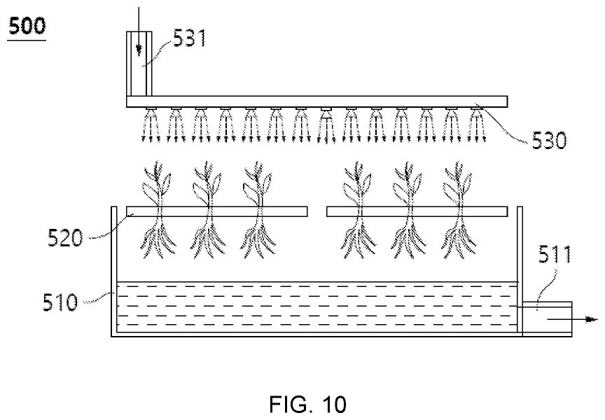

FIG. 1 is a block configuration view of a system for recycling waste heat using a solid refuse fuel incinerator according to an exemplary embodiment of the present disclosure, FIGS. 2 to 5 are views for explaining a solid refuse fuel incinerator according to the exemplary embodiment of the present disclosure, FIG. 6 is a view for explaining a harmful material precipitator according to the exemplary embodiment of the present disclosure, FIG. 7 is a view for explaining a precipitation water filtering device according to the exemplary embodiment of the present disclosure, FIGS. 8 and 9 are views for explaining a steam power generator according to the exemplary embodiment of the present disclosure, and FIG. 10 is a view for explaining a hydroponic apparatus according to the exemplary embodiment of the present disclosure.

Referring to FIGS. 1 to 10, the system for recycling waste heat using a solid refuse fuel incinerator according to the exemplary embodiment of the present disclosure may include a solid refuse fuel incinerator 100, a harmful material precipitator 200, a precipitation water filtering device 300, a steam power generator 400, and a hydroponic cultivator 500.

The solid refuse fuel incinerator 100 is configured to incinerate solid refuse fuel (SRF) supplied into the solid refuse fuel incinerator 100 and discharge an exhaust gas produced during the incineration. For example, a reverse feed stoker incinerator for incinerating the solid refuse fuel while conveying the solid refuse fuel from the bottom side to the top side may be provided as the solid refuse fuel incinerator 100. The stoker may be made of iron (Fe) or the like in order to improve heat transfer.

The solid refuse fuel incinerator 100 may include an incinerator main body 110, a supply conveyor 120, a primary incineration region 130, a secondary incineration region 140, a tertiary incineration region 150, an air blower 160, and a heating means 170.

The incinerator main body 110 has therein an incineration space and has a supply passage 111 through which the solid refuse fuel is supplied, and a first exhaust pipe 112 through which the exhaust gas is discharged. The supply passage 111 may be provided at a lower side of the incinerator main body 110, and the first exhaust pipe 112 may be provided at an upper side of the incinerator main body 110.

The supply conveyor 120 may supply the solid refuse fuel into the incinerator main body 110. The solid refuse fuel may be conveyed, by the supply conveyor 120, to the primary incineration region 130 provided at a lowermost stage in the incinerator main body 110, and then the solid refuse fuel may be supplied to an upper portion of a first stationary stoker 131 provided in the primary incineration region 130.

In the primary incineration region 130, the solid refuse fuel may be supplied to the primary stoker and primarily incinerated. The stokers may include the first stationary stoker 131 provided in the primary incineration region 130, and a first movable stoker 132 configured to convey a non-combusted material from the primary incineration region 130 to the secondary incineration region 140.

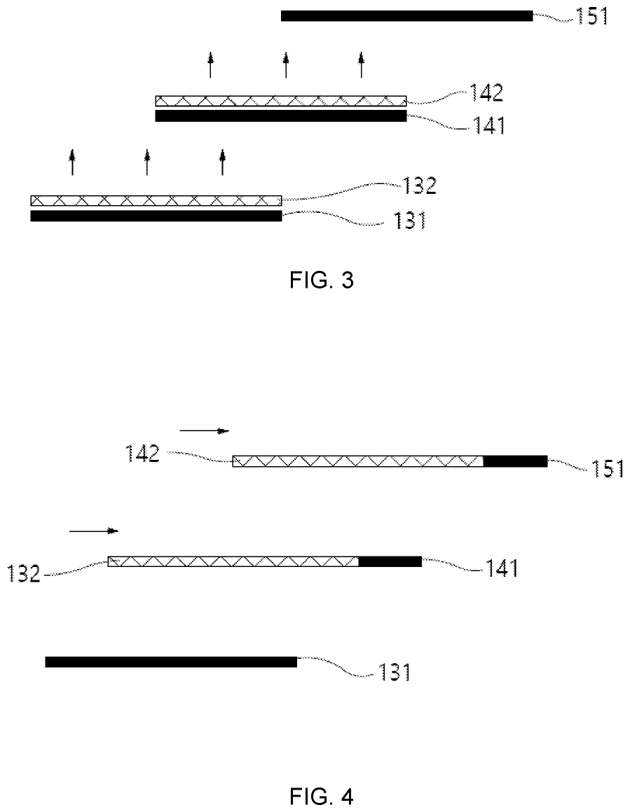

For example, as illustrated in FIG. 3, the first movable stoker 132 disposed adjacent to the first stationary stoker 131 may move upward to convey the non-com busted material remaining after the primary incineration. As illustrated in FIG. 4, the first movable stoker 132 may move in a direction toward a second stationary stoker 141 and then convey the non-combusted material remaining after the primary incineration to an upper portion of the second stationary stoker 141.

In this case, the solid refuse fuel supplied to the first stationary stoker 131 may be ignited by an igniter 171 of the heating means 170 and thus primarily incinerated in a temperature range of about 1,000 to 1,200° C. After the primary incineration, the non-combusted material, which is not completely combusted and remains after the primary incineration, may be conveyed by the first movable stoker 132 to the secondary incineration region 140 positioned above the primary incineration region 130.

In addition, the first stationary stoker 131 may be provided to be rotatable by 360 degrees to uniformly incinerate the solid refuse fuel.

The secondary incineration region 140 is disposed above the primary incineration region 130 and communicates with the primary incineration region 130, and the non-combusted material remaining after the primary incineration may be secondarily incinerated. The stokers may include the second stationary stoker 141 provided in the secondary incineration region 140, and a second movable stoker 142 configured to convey the non-combusted material from the secondary incineration region 140 to the tertiary incineration region 150.

For example, as illustrated in FIG. 3, the second movable stoker 142 disposed adjacent to the second stationary stoker 141 may move upward to convey the non-combusted material remaining after the secondary incineration. As illustrated in FIG. 4, the second movable stoker 142 may move in a direction toward a third stationary stoker 151 and then convey the non-combusted material remaining after the secondary incineration to an upper portion of the third stationary stoker 151.

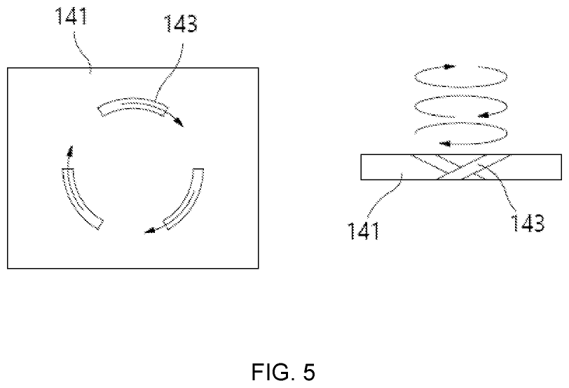

The second stationary stoker 141 provided in the secondary incineration region 140 may have heating holes 143 that penetrate the upper and lower portions of the second stationary stoker 141. The heating holes 143 are inclined upward and disposed in a split ring shape, as illustrated in FIG. 5. The heat in the primary incineration region 130 is transferred through the heating holes 143, and the non-combusted material is incinerated in a temperature range of about 1,200 to 1,700° C. by a first heating pipe 171 of the heating means 170 which is provided in the secondary incineration region 140, such that a harmful material containing dioxin or the like may be effectively incinerated.

The heat in the primary incineration region 130 may be effectively transferred to the secondary incineration region 140 through the heating holes 143 disposed in a split ring shape while circularly rotating upward at an angle of 360 to 720 degrees, as illustrated in FIG. 5. In the exemplary embodiment of the present disclosure, the three heating holes 143 may be provided in a split ring shape, and each of the three heating holes 143 may be inclined upward.

The tertiary incineration region 150 is disposed above the secondary incineration region 140 and communicates with the secondary incineration region 140, and the non-combusted material remaining after the secondary incineration may be tertiarily incinerated. The stokers may include the third stationary stoker 151 provided in the tertiary incineration region 150, and the non-combusted material remaining after the secondary incineration is conveyed to the third stationary stoker 151 by the second movable stoker 142. The non-combusted material is incinerated in a temperature range of about 1,200 to 1,500° C. by a second heating pipe 172 provided in the tertiary incineration region 140, such that the remaining non-combusted harmful material may be completely incinerated.

The air blower 160 may supply air to the primary incineration region 130 in order to ignite and incinerate the solid refuse fuel supplied to the first stationary stoker 131 in the primary incineration region 130 at a high temperature. The air blower 160 may be disposed adjacent to the supply passage 111 in order to smoothly supply the air to the primary incineration region 130.

The heating means 170 may heat the primary incineration region 130, the secondary incineration region 140, and the tertiary incineration region 150. The igniter 171 for incinerating the solid refuse fuel may be provided in the primary incineration region 130, the first heating pipe 172 and the second heating pipe 173 may be provided in the secondary incineration region 140 and the tertiary incineration region 150, respectively. The first heating pipe 172 and the second heating pipe 173 may maintain a temperature range of about 1,450 to 1,550° C.

Therefore, in the primary incineration region 130, the supplied solid refuse fuel may be ignited and incinerated. In the secondary incineration region 130, the solid refuse fuel may be incinerated, by the heat transferred from the primary incineration region 130 and the heating by the first heating pipe 172, at a temperature relatively higher than the temperature in the primary incineration region 130. In the tertiary incineration region 130, the solid refuse fuel may be additionally incinerated by the heating by the second heating pipe 173.

As described above, in the solid refuse fuel incinerator 100, the first stationary stoker 131, the second stationary stoker 141, and the third stationary stoker 151 are provided in the primary incineration region 130, the secondary incineration region 140, and the tertiary incineration region 150, respectively. The non-combusted material remaining after the incineration may be moved to the subsequent incineration region by the first movable stoker 132 and the second movable stoker 141.

The harmful material precipitator 200 is configured to adsorb and precipitate harmful materials (e.g., harmful gas, dust, and the like) by injecting adsorption water (A.W) to the exhaust gas discharged from the solid refuse fuel incinerator 100. The harmful material precipitator 200 may include a precipitator main body 210, an adsorption water tub 220, water injection nozzles 230, and a plurality of partition walls 240.

The precipitator main body 210 is provided in a tubular shape. The exhaust gas from the solid refuse fuel incinerator 100 may be introduced into the precipitator main body 210, and high-temperature air and precipitation water (P.W) in which the harmful material is adsorbed and precipitated may be discharged from the precipitator main body 210. For example, the precipitator main body 210 is provided in a tubular shape having a quadrangular cross section. The exhaust gas may be introduced into the precipitator main body 210 through a first inlet pipe 211 that communicates with the first exhaust pipe 112.

The precipitator main body 210 may have a first drain pipe 212 through which the precipitation water is discharged to the precipitation water filtering device 300, and a second exhaust pipe 213 through which the high-temperature air is discharged to the outside.

A plurality of adsorption water supply pipes 220 may be provided in a longitudinal direction at an upper side in the precipitator main body 210 and may supply the water supplied from the hydroponic cultivator 500 so that the water is used as the adsorption water.

The water injection nozzles 230 may be provided on the adsorption water supply pipe 220 and may inject downward the adsorption water stored in the adsorption water tub 220. The water injection nozzles 230 are provided in the longitudinal direction at the upper side in the precipitator main body 210 and inject the adsorption water, which is supplied from the hydroponic cultivator 500, to the exhaust gas that moves from a front end to a rear end of the precipitator main body 210. As a result, the adsorption water adsorbs harmful gas such as nitrogen and harmful materials containing contaminants such as dust so that harmful materials settle on the bottom of the precipitator main body 210.

The plurality of water injection nozzles 230 may be provided on the adsorption water supply pipe 221 provided in the longitudinal direction at the upper side in the precipitator main body 210 and may uniformly inject the adsorption water into the entire space in the precipitator main body 210. In the exemplary embodiment of the present disclosure, the configuration in which the adsorption water supply pipe 220 is provided in a straight shape and installed to penetrate the plurality of partition walls 240 to be described below is described. However, the adsorption water supply pipe 220 may of course be variously disposed and formed in accordance with the shape of the inside of the precipitator main body 210.

The plurality of partition walls 240 may be provided at the upper side in the precipitator main body 210 and may inhibit the movement of the exhaust gas. The plurality of partition walls 240 protrudes downward from an upper surface in the precipitator main body 210 in a direction perpendicular to the longitudinal direction, thereby preventing the exhaust gas from moving at an excessively high speed when the exhaust gas moves from the front end to the rear end of the precipitator main body 210. Therefore, the harmful material may be effectively adsorbed and precipitated from the exhaust gas.

Further, the plurality of partition walls 240 reduces a movement speed of the exhaust gas, such that the high-temperature air may be cooled by means of heat exchange with the precipitation water settling at a lower side of the precipitator main body 210 so that a temperature of the high-temperature air discharged from the precipitator main body 210 may also be appropriately maintained.

The precipitation water filtering device 300 is configured to filter and purify the precipitation water in which the harmful materials are adsorbed and precipitated. The plurality of precipitation water filtering devices 300 may be provided and each may include a filtering device main body 310 and an activated carbon filter 320.

The precipitation water may be introduced into the filtering device main body 310, and clean water from which the harmful materials are removed may be discharged from the filtering device main body 310. The filtering device main body 310 may have a second inlet pipe 311 through which the precipitation water is introduced, and a second drain pipe 312 through which the clean water is discharged. The activated carbon filter 320 may be provided in the filtering device main body 310 to adsorb and remove the harmful materials.

The plurality of precipitation water filtering devices 300 may be provided to smoothly remove the harmful materials. In the exemplary embodiment of the present disclosure, the three precipitation water filtering devices 300 may be provided. The precipitation water filtering devices 300 may be connected with a connection pipe 300a. Pumps P may be provided in the second inlet pipe 311, the second drain pipe 312, and the connection pipe 300a, respectively, such that the precipitation water introduced into the precipitation water filtering device 300 may be sequentially filtered and then smoothly discharged to the drain pipe 312.

In the exemplary embodiment of the present disclosure, the pumps P are illustrated as being provided in the second inlet pipe 311 and the second drain pipe 312. However, the pump P may of course be provided in the connection pipe 300a.

Meanwhile, the activated carbon filter 320 is provided at a central portion of the precipitator main body 310. In a first precipitator, the harmful materials are filtered out while the precipitation water moves downward. In a second precipitator, the harmful materials are filtered out while a level of the precipitation water increases upward. In a third precipitator, the harmful materials are filtered out while the precipitation water moves downward, and then the precipitation water may be discharged.

The steam power generator 400 is configured to generate electricity using steam produced by heat exchange between waste heat of the incinerator and a cooling water supplied to cool the solid refuse fuel incinerator 100. The steam power generator 400 may include a heat exchange pipe 410, a steam turbine 420, and an electric generator 430.

The heat exchange pipe 410 is provided in the solid refuse fuel incinerator 100, and cooling water (C.W) is supplied to the heat exchange pipe 410. The heat exchange pipe 410 may discharge the steam produced by the heat exchange with the waste heat of the solid refuse fuel incinerator 100. The heat exchange pipe 410 may be provided on the main body of the solid refuse fuel incinerator 100 or provided on the stoker of the solid refuse fuel incinerator 100 (e.g., a lower portion of the first stationary stoker 131, the second stationary stoker 141, or the third stationary stoker 151).

For example, as illustrated in FIG. 8, the heat exchange pipe 410 may be provided in the main body of the solid refuse fuel incinerator 100 so as to surround the main body. Alternatively, as illustrated in FIG. 9, the heat exchange pipe 410 may be disposed and provided on a lower portion of the first stationary stoker 131.

The steam turbine 420 may operate using the discharged steam, and the electric generator 430 may be connected to the steam turbine 420 and may generate electricity. The high-temperature, high-pressure steam transmitted through the heat exchange pipe 410 operates the steam turbine 420, and the electric generator 430 connected to the steam turbine 420 converts kinetic energy, which is generated by a rotational operation of the steam turbine 420, into electrical energy, thereby generating electricity using the steam.

The hydroponic cultivator 500 is supplied with the clean water purified by the precipitation water filtering device 300 and performs hydroponics using the supplied clean water and the electricity generated by the steam power generator 400. The water used for the hydroponics may be supplied again as the adsorption water.

For example, as illustrated in FIG. 10, the hydroponic cultivator 500 has a cultivator main body 510 having an opened cultivation space, and a plurality of cultivation beds 520 which is disposed in the cultivator main body 510 and on which plants or crops for hydroponics are disposed. A plurality of water spray pipes 530 may be provided so that the clean water supplied through the precipitation water filtering device 300 is sprayed to the plants or crops disposed on the cultivation beds 520.

In this case, electricity may be supplied to various devices (e.g., an air blower, an air conditioner, and the like) provided in the cultivator main body 510 and configured to control a hydroponic environment in the hydroponic cultivator 500. The clean water sprayed for hydroponics is stored at a lower side of the cultivator main body 510. The cultivator main body 510 may have a water discharge pipe 511 which is opened to discharge the water to the harmful material precipitator 200 when a level of the clean water reaches a predetermined level.

In addition, a clean water supply pipe 531 may be provided on the water spray pipe 530 in order to adjust a temperature of the clean water, which is supplied from the precipitation water filtering device 300, to a temperature suitable for the hydroponics.

Meanwhile, the pipes provided in the system for recycling waste heat may of course have valves for opening and closing the pipes as necessary, and the flow of water or gas may be allowed or stopped by opening or closing the valves.

Therefore, according to the present disclosure, the adsorption water is injected to the exhaust gas, which is produced during the incineration of the solid refuse fuel, to adsorb contaminants, the precipitation water, in which the contaminants are adsorbed, is filtered to remove the contaminants, the water is supplied to be used as the precipitation water and used for the hydroponics, and the electricity is generated using the steam produced as the solid refuse fuel incinerator is cooled. As a result, it is possible to effectively recycle the waste heat and the exhaust gas, which are generated during the incineration of the solid refuse fuel, in order to generate electricity and perform hydroponics.

Further, according to the present disclosure, the solid refuse fuel is supplied to and incinerated by the stoker incinerator, the solid refuse fuel is primarily incinerated at a lowermost stage, the non-combusted material remaining after the primary incineration is secondarily incinerated at an upper stage positioned above the lowermost stage, and the non-combusted material remaining after the secondary incineration is tertiarily incinerated at a stage positioned above the upper stage. As a result, it is possible to completely incinerate the harmful materials containing dioxin.

In addition, according to the present disclosure, the exhaust gas, which is produced during the incineration of the solid refuse fuel, is introduced into and discharged from the harmful material precipitator, the water supplied from the hydroponic cultivator is injected downward, as the adsorption water, to adsorb and precipitate the harmful gas and the contaminants, and the harmful gas and the contaminants are removed from the precipitation water, and then the clean water is discharged. As a result, it is possible to recycle and use the discharged clean water for the hydroponics.

Further, according to the present disclosure, the cooling water is supplied to cool the solid refuse fuel incinerator, the steam is produced by the heat exchange between the supplied cooling water and the waste heat of the incinerator, and the electricity is generated using the steam. As a result, it is possible to perform the hydroponics using the generated electricity.

While the present disclosure has been shown and described in connection with the exemplary embodiments, it will be apparent to those skilled in the art that modifications and variations can be made without departing from the spirit and scope of the disclosure as defined by the appended claims.

What is claimed is:

1. A system for recycling waste heat using a solid refuse fuel incinerator, the system comprising:
a solid refuse fuel incinerator configured to incinerate solid refuse fuel supplied into the solid refuse fuel incinerator, the solid refuse fuel incinerator being configured to discharge exhaust gas produced during the incineration;
a harmful material precipitator configured to adsorb and precipitate a harmful material by injecting adsorption water to the discharged exhaust gas;
a precipitation water filtering device configured to filter and purify precipitation water in which the harmful material is adsorbed and precipitated;
a steam power generator configured to generate electricity using steam produced by heat exchange between waste heat of the incinerator and cooling water supplied to cool the solid refuse fuel incinerator; and
a hydroponic cultivator configured to be supplied with clean water purified by the precipitation water filtering device and perform hydroponics using the supplied clean water and the generated electricity, the hydroponic cultivator being configured such that the water used for the hydroponics is supplied again as the adsorption water,
wherein the solid refuse fuel incinerator is a reverse feed stoker incinerator that incinerates the solid refuse fuel while conveying the solid refuse fuel from a bottom side to a top side, and
wherein the solid refuse fuel incinerator comprises:
an incinerator main body having an incineration space therein and comprising a supply passage through which the solid refuse fuel is supplied, and a first exhaust pipe through which the exhaust gas is discharged;
a supply conveyor configured to the solid refuse fuel into the incinerator main body;
a primary incineration region in which the solid refuse fuel is supplied to a primary stoker and primarily incinerated;
a secondary incineration region disposed above the primary incineration region and communicating with the primary incineration region, the secondary incineration region being configured such that non-combusted material remaining after the primary incineration is secondarily incinerated;
a tertiary incineration region disposed above the secondary incineration region and communicating with the secondary incineration region, the tertiary incineration region being configured such that the non-combusted material remaining after the secondary incineration is tertiarily incinerated;
an air blower configured to supply air to the primary incineration region; and
a heating means configured to heat the primary incineration region, the secondary incineration region, and the tertiary incineration region.

2. The system of claim 1, wherein the solid refuse fuel incinerator has stationary stokers provided in the primary incineration region, the secondary incineration region, and the tertiary incineration region, respectively, and after the incineration, a movable stoker is used to move the non-combusted material to the subsequent incineration region.

3. The system of claim 2, wherein a second stationary stoker in the secondary incineration region has heating holes that penetrate upper and lower portions of the second stationary stoker and are inclined upward and disposed in a split ring shape.

4. The system of claim 3, wherein the harmful material precipitator comprises:
a tubular precipitator main body into which the exhaust gas is introduced and from which high-temperature air and the precipitation water, in which the harmful material is adsorbed and precipitated, are discharged;
an adsorption water supply pipe provided at an upper side in the precipitator main body and configured to supply water from the hydroponic cultivator as the adsorption water; and
a water injection nozzle provided on the adsorption water supply pipe and configured to inject the adsorption water downward.

5. The system of claim 4, wherein the harmful material precipitator further comprises a plurality of partition walls provided at the upper side in the precipitator main body and configured to inhibit a movement of the exhaust gas.

6. The system of claim 5, wherein the precipitator main body comprises:
a first inlet pipe into which the exhaust gas is introduced;
a first drain pipe through which the precipitation water is discharged to the precipitation water filtering device; and
a second exhaust pipe through which the high-temperature air is discharged to the outside.

7. The system of claim 6, wherein the plurality of precipitation water filtering devices is provided, and
wherein each of the precipitation water filtering devices comprises:
a filtering device main body into which the precipitation water is introduced and from which the clean water from which the harmful material is removed is discharged; and
an activated carbon filter provided in the filtering device main body and configured to adsorb and remove the harmful material.

8. The system of claim 7, wherein the filtering device main body comprises:
a second inlet pipe into which the precipitation water is introduced; and
a second drain pipe from which the clean water is discharged.

9. The system of claim 1, wherein the steam power generator comprises:
a heat exchange pipe provided in the solid refuse fuel incinerator and configured to be supplied with the cooling water and to discharge steam generated by heat exchange with the waste heat;
a steam turbine configured to operate using the discharged steam; and
an electric generator connected to the steam turbine and configured to generate electricity.

10. The system of claim 9, wherein the heat exchange pipe is provided in the main body of the solid refuse fuel incinerator or provided on the stoker of the solid refuse fuel incinerator.
